(19) United States
(12) Patent Application Publication
(10) Pub. No.: US 2024/0430266 A1
(43) Pub. Date: Dec. 26, 2024

(54) METHODS FOR GENERATING, PROVIDING AND MANAGING PROFILES OF CERTIFIED IDENTITIES, AND ELECTRONIC IDENTITY WALLET

(71) Applicant: ORANGE, Issy-les-Moulineaux (FR)

(72) Inventors: Stéphane Petit, CHATILLON CEDEX (FR); Anke Hedrich, CHATILLON CEDEX (FR); Olivier Berteche, CHATILLON CEDEX (FR)

(21) Appl. No.: 18/747,759

(22) Filed: Jun. 19, 2024

(30) Foreign Application Priority Data
Jun. 20, 2023 (FR) 2306352

(51) Int. Cl. H04L 9/40

(52) U.S. Cl. CPC H04L 63/102

(57) ABSTRACT

Methods for generating, providing and managing profiles of certified identities, and an electronic identity wallet. The method generates profiles of certified identities associated with a user account for an electronic identity wallet and includes: selecting, for a profile of certified identities, identity data from a set of identity data received from at least one certified identity provider associated with the user account; then integrating the selected identity data into the recipient profile of certified identities. This will reduce risks of service provision errors and service provision failures. This also reduces the time taken to transmit identity data via the electronic wallet, thus reducing the ongoing processing time taken by the service provider when requesting identity data, recording a new user, providing a service, etc.

### CROSS REFERENCE TO RELATED APPLICATION

This application claims priority to French Patent Application No. FR 2306352 filed on Jun. 20, 2023, the content of which is incorporated herein by reference in its entirety.

### TECHNICAL FIELD

The present disclosure is in the field of digital identity management. It relates to methods for generating, providing and managing profiles of certified identities, and an electronic identity wallet.

### PRIOR ART

Many service providers, online or nearline, require the provision of user identity elements in order to deliver their service. Traditionally, in a non-digital world, this provision of identity elements is carried out using physical documents issued by official authorities (identity card, driving license, etc.) and various supporting documents issued by recognized third-party certifiers (energy bill, telecoms bill, medical certificate, etc.).

The development of Internet-accessible services involves implementing dedicated tools for digitizing the elements present on the aforementioned media, optionally in a structured manner, and authorizing them to be shared with the service provider following consent from the user. In this context, in the field of identity management a solution is proposed that centralizes the identity elements of the user and authorizes, under the control of the user, access by the service to all or some of the identity elements of the user, notably using an OIDC (OpenID Connect) protocol. Consequently, at present, if a service provider requires certified identity data, notably in order to create and/or modify a user account for one or more services provided by this service provider, the solution involves the service provider corresponding with a certified identity provider with which the user has previously registered.

[symbol]

However, the service provider is then aware of the certified identity provider of the user and has access to all the identity data concerning the user that is held by this identity provider. Furthermore, a single identity provider may not have all the identity data required by the service provider.

[symbol]

In addition, the identity provider is aware of each time the user uses one of the services where they provide the identity elements of the user, including the time the service was used and which identity elements the user shares with them. Thus, the identity provider is capable of generating a profile of the use of services by a user from the history of the service activities of the user.

The electronic identity wallet was notably designed to address these problems. Thus, it is an identity management system for maintaining the privacy of users. The electronic wallet is a Self-Sovereign Identity (SSI) solution that dissociates the identity provider from the issuer issuing a service provider with identity elements, notably by using a SIOP (Self-Issued OpenID Provider) protocol.

Indeed, such an electronic identity wallet retrieves/gathers identity data, and optionally the certificates of the identity element (also called “ID-tokens”), from one or more separate identity providers where it is registered. The electronic wallet therefore maintains the privacy of the user since it acts as a mediator between service providers requiring certified identity data and the identity providers with which the user is registered. The service provider is therefore unaware of the identity providers of the user.

Furthermore, using the electronic wallet does not require a connection with the identity provider when transmitting certified identity data to the service provider. The identity data is then transmitted in an “asynchronous” manner since the identity data is sent to the service provider without the identity provider being involved in a synchronous manner.

Furthermore, in order to respond to the request for identity data, the user of the electronic wallet selects one or more identity data items from the gathered identity data recorded in the electronic wallet and authorizes them to be transmitted by the electronic wallet to the service provider in response to the request. Thus, the service provider does not have access to the other identity data available in the electronic wallet. The user is therefore in control of sharing their identity data with a service provider.

The aforementioned use nevertheless has disadvantages, notably such as:

Longer registration times with a service provider, or even longer service provision times, due to the time required for the user to select each required identity data item from the set of gathered identity data, given that this may require the source identity provider to be selected beforehand for each identity data item.

Furthermore, when several identity data items have been gathered from various identity providers for the same type of identity data, there is a risk that the user does not select the same identity data in order to respond to the same service provider (notably during a request for confirmation of identity by the service provider) or a second service provider communicating with a first service provider. This can cause service provision errors (because the service provider considers that it is dealing with two distinct users), notably a failure to take into account the history, the loyalty and the profile of the user, or even a request to create a new account, etc.; or even a failure in service provision.

### SUMMARY

An aspect of the present disclosure relates to a method for generating profiles of certified identities associated with a user account for an electronic identity wallet, the generation method comprising: [symbol]
selecting, for a profile of certified identities, identity data from a set of identity data received from at least one certified identity provider associated with the user account; then
integrating the selected identity data into the recipient profile of certified identities.

Thus, this will reduce the risk of service provision errors and service provision failures. Indeed, for the same service provider, the electronic identity wallet will be capable of transmitting the same profile of certified identities containing the same identity data upon each request from the service provider, without any risk of error.

[symbol]

Another advantage is that it reduces the time taken to transmit identity data via the electronic wallet, thus reducing the ongoing processing time taken by the service provider when requesting identity data: recording a new user, providing a service, etc.

Advantageously, at least one identity data item is selected as a function of identity data required by at least one service provider.

Advantageously, at least one identity data item is selected as a function of a selection command received from a user interface.

Advantageously, the generation method comprises: recording the generated profile of certified identities.

Advantageously, when the profile of certified identities is intended for a type of service provider, the selection is carried out as a function of the type of service provider associated with the profile of certified identities.

Advantageously, the integration of the selected identity data in the profile of certified identities is triggered as soon as the electronic identity wallet provides a service provider with the selected identity data, with the profile of certified identities being associated with the service provider.

A further aspect of the present disclosure relates to a method for providing a service provider with certified identity data, the provision method comprising:
retrieving the identity data required by a service provider from the identity data of a profile of certified identities; and
transmitting the identity data retrieved from the profile of certified identities to the requesting service provider.

Advantageously, the provision method comprises:
receiving a transmission agreement prior to transmitting the identity data.

Advantageously, the identity data intended for a service provider is retrieved from an identity profile that has previously been used to provide the same service provider with certified identity data.

A further aspect of the present disclosure relates to a method for managing profiles of certified identities associated with a user account for an electronic identity wallet, the management method comprising generating a profile of certified identities according to the generation method of the disclosure.

Advantageously, the management method comprises:
modifying a profile of certified identities by modifying at least one identity data item of the profile of certified identities.

Advantageously, the modification is a modification from among the following modifications: [symbol]
adding a selected identity data item, for the profile of certified identities, from a set of identity data received from at least one certified identity provider associated with the user account;
deleting an identity data item from the profile of certified identities.

Advantageously, the management method comprises:

providing a service provider with identity data according to the provision method of the disclosure.

Advantageously, according to one implementation of the disclosure, the various steps of the method according to an aspect of the present disclosure relates to are implemented by a software program or a computer program, with this software comprising software instructions intended to be executed by a data processor of a device forming part of an electronic identity wallet and being designed to control the execution of the various steps of this method.

Therefore, an aspect of the present disclosure also relates to a program comprising program code instructions for executing the steps of the method for generating profiles of certified identities according to the disclosure and/or of the method for providing certified identity data according to the disclosure and/or of the method for managing profiles of certified identities according to the disclosure when said program is executed by a processor.

This program can use any programming language and can be in the form of source code, object code or intermediate code between source code and object code, such as in a partially compiled format or in any other desirable format.

A further aspect of the present disclosure relates to an electronic identity wallet capable of providing certified identity data comprising a generator for generating profiles of certified identities associated with a user account of the electronic identity wallet, the generator for generating profiles of certified identities being capable of [symbol]
selecting, for a profile of certified identities, identity data from a set of identity data received from at least one certified identity provider associated with the user account; then
integrating the selected identity data into the recipient profile of certified identities.

### BRIEF DESCRIPTION OF THE DRAWINGS

The features and advantages of the present disclosure will become more clearly apparent upon reading the description, which is provided by way of an example, and the related figures, which show:

FIG. 1, a simplified diagram of the method for generating profiles of certified identities according to an aspect of the present disclosure;

FIG. 2, a simplified diagram of the method for providing certified identity data according to an aspect of the present disclosure;

FIG. 3, a simplified diagram of the method for managing profiles of certified identities according to an aspect of the present disclosure;

FIG. 4, a simplified diagram of a communication architecture comprising a wallet of certified identities according to an aspect of the present disclosure;

FIG. 5, a simplified diagram of the user interface granting access to an electronic wallet of certified identity data according to an aspect of the present disclosure;

FIG. 6a, a simplified diagram of the user interface during a first step of generating a profile according to an aspect of the present disclosure in a first embodiment;

FIG. 6b, a simplified diagram of the user interface during a second step of generating a profile according to an aspect of the present disclosure in a first embodiment;

FIG. 7a, a simplified diagram of the user interface during a first step of generating a profile according to an aspect of the present disclosure in a second embodiment;

FIG. 7b, a simplified diagram of the user interface during a second step of generating a profile according to an aspect of the present disclosure in a second embodiment;

FIG. 8, a simplified diagram of the user interface showing an example of a profile generated according to the an aspect of the present disclosure.

### DESCRIPTION OF THE EMBODIMENTS

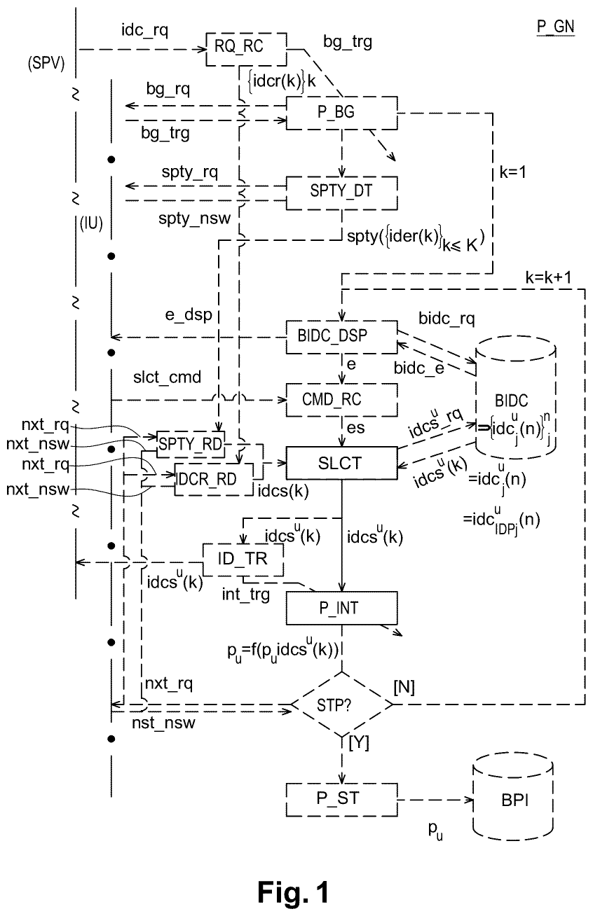

FIG. 1 illustrates a simplified diagram of the method for generating profiles of certified identities according to an aspect of the present disclosure.

The method P_GN for generating profiles of certified identities generates profiles ρu of certified identities associated with a user account in an electronic identity wallet. The generation method P_GN comprising: [symbol]
selecting SLCT, for a profile ρu of certified identities, identity data idcs^{U}(k) from a set of identity data {idcⱼ^{U}(n)}ⱼⁿ received from at least one certified identity provider IDPⱼ associated with the user account U; then
integrating P_INT the selected identity data idcs^{U}(k) into the recipient profile ρu of certified identities.

In particular, the identity data are certified identity data. A certified identity data item notably comprises a specific identity data item and an identity certificate, notably an identity token, also called “ID-token”. Optionally, the certificate comprises the specific identity data item. The specific identity data item is, for example, a data item from among the following data items: a surname, a forename, a postal address, an email address, a telephone number, a date of birth, etc.

In particular, certified identity data is selected SLCT from at least one identity data item as a function of identity data idcr(k) required by at least one service provider SPV.

In particular, when the requesting service provider SPV has a requirement relating to the identity provider (notably an identity provider quality requirement, a requirement concerning the identity provider themselves), certified identity data is selected SLCT from at least one identity data item not only as a function of identity data idcr(k) required by at least one service provider SPV, but also as a function of parameters of the identity provider where the selectable certified identity data originates. The parameters of the identity provider notably include the quality of the certified identity data, the name of the identity provider, the category (for example: sovereign, commercial, etc.), etc. Thus, the service provider can refuse the identity data originating from certain identity providers and/or identity providers whose quality is lower than a threshold quality value and/or non-sovereign identity providers, etc.

In particular, certified identity data is selected SLCT from at least one identity data item as a function of a selection command slct_cmd received from a user interface IU.

In particular, the generation method P_GN comprises:
recording P_ST the generated profile of certified identities.

In particular, when the profile ρu of certified identities is intended for a type spty of service provider, certified identity data is selected SLCT as a function of the type spty of service provider associated with the profile ρu of certified identities.

In particular, the integration P_INT of the selected identity data idcs^{U}(k) in the profile ρu of certified identities is triggered int_trg as soon as the electronic identity wallet provides ID_TR a service provider SPV with the selected identity data idcs^{U}(k), with the profile ρu of certified identities being associated with the service provider SPV.

In particular, the generation method P_GN comprises:
starting the generation P_BG of a new profile associated with the user account U

[symbol]

In particular, starting the generation P_GB of a new profile is notably triggered bg_trg [symbol]
either by a request for a new profile b_trg from the user interface IU; or
following the reception RQ_RC of a request idc_rq for certified identity data from a service provider SPV.

In the first case, starting the generation P_BG of a new profile involves asking b_rq a user interface IU whether the generation of a new profile is desired. In response to this request b_rq, the user interface IU triggers the start of the generation P_BG of a new profile.

In the second case, either the management method implemented by the certified identity wallet (not illustrated in FIG. 1) or the generation method P_GN comprises:-receiving RQ_RC the request idc_rq for certified identity data;
then triggering bg_trg the start of the generation P_GB of a new profile.

In particular, the generation method P_GN comprises:
determining SPTY_DT a type spty of service provider with which the profile ρu of certified identities being generated will be associated.

In the first case, the type spty of service provider is indicated by the user interface IU. Notably, determining SPTY_DT the type of service provider involves receiving a type spty_nsw of service provider from the user interface IU, for example, in response to a request spty_rq for a type of service provider sent to the user interface U when determining SPTY_DT the type of service provider.

In the second case, the type spty of service provider is the type relating to the requesting service provider SPV.

Determining SPTY_DT the type of service provider notably involves determining the certified identity data {idcr(k)}_{k≤K} generally required by the determined type spty of service provider: spty ({idcr(k)}_{k≤K}). “Generally required by” is understood to mean the certified identity data associated with the type of service provider recorded prior to the generation P_GN of a profile, and/or the history of the identity data associated with the service providers of the determined requesting type prior to the generation P_GN of the current profile, and/or the certified identity data associated with the type of service provider by learning, etc.

In particular, the generation method P_GN generates the profile by iteration, i.e., for a profile ρu comprising several identity data items, the generation method selects SLCT and then integrates P_INT one identity data item after the other in the profile ρu.

For example, starting the profile P_BG sets the iteration counter to 1:k=1, then triggers the selection SLCT and the integration P_INT of a first selected identity data item idcs^{U}(k=1) in the profile pu: p_{U}=ƒ(p_{U}=Ø, idcs^{U}(k=1)). The generation method P_GN notably comprises an iteration k=k+1 as long as the generation of the profile has not been completed [N], allowing the selection SLCT and integration of a k^{th} selected identity data item idcs^{U}(k) in the profile ρu being generated: p_{U}=ƒ(p_{U}, idcs^{U}(k)).

In particular, in the case whereby profile generation P_GN is carried out by selecting SLCT and integrating P_INT, in the profile p_{U}, a selected certified identity data item idcs(k) as a function of a command slct_cmd received from a user interface IU, then the generation method P_GN notably comprises one or more of the following steps [symbol]
providing BIDC_DSP elements e_dsp to be reproduced relating to the certified identity data as a function of the certified identity data associated with the user account U available bidc_e in the certified identity wallet, optionally upon a request bidc_rq for the provision BIDC_DSP of elements to be reproduced relating to the certified identity data BIDC_DSP: [symbol]
receiving CMD_RC a selection command slot_cmd for a reproduced element e notifying the step SLCT of selecting certified identity data of the selected reproduced element es as a function of which the selection step determines the corresponding certified identity data idcs.

In particular, the certified identity data idc originating from one or more certified identity sources IDP, IDP1 . . . . IDP_{J} (not illustrated) has been previously recorded, for example, in a certified identity database BIDC.

In particular, in the case whereby profile generation P_GN is carried out as a function of the determined type spty of service provider, then the generation method P_GN notably comprises one or more of the following steps: [symbol]
reading SPTY_RD the certified identity data required by the selected type spty of service provider. Reading SPTY_RD notifies the step SLCT of selecting certified identity data of a k^{th} required certified identity data item idcr(k).

In particular, in the case whereby profile generation P_GN is carried out following a request to provide certified identity data idc_rq from a service provider SPV, then the generation method P_GN notably comprises one or more of the following steps [symbol]
reading IDCR_RD the certified identity data required by the service provider SPV. Reading IDCR_RD notifies the step SLCT of selecting certified identity data of the required certified identity data idcr(k);
providing ID_TR the requesting service provider SPV with the selected certified identity data idcs(k).

In particular, the selection step SLCT requests the selected certified identity data idcs^{U}_rq, notably from the certified identity database BIDC, which then supplies the selected certified identity data idcs^{U}(k) notably corresponding to one of the certified identity data items provided by one of the certified identity providers IDPⱼ: idcs^{U}(k)=idcⱼ^{U}(n)=idc_{IDPj}^{U}(n). The certified identity database BIDC comprises certified identity data idc, notably all the certified identity data provided by one or more certified identity providers IDP, IDP_{j.j=1 . . . J}: {idcⱼ^{U}(n)}ⱼⁿ.

In particular, the generation method P_GN comprises a check STP? for checking the generation stage of the profile after the integration P_INT of a certified identity data item selected from the profile ρu being generated.

In particular, in the case of a profile generated as a function of a determined type spty of service provider, the check STP? notably determines whether all the data {idcr(k)} associated with this determined type spty of service provider has been provided: spty ({idcr(k)}).

[symbol]

In particular, in the case of a profile generated when providing a service provider with identity data, the check STP? notably determines whether all the data idcr(k) required by the service provider SPV has been provided.

In particular, in the case of a profile generated by selection slot_cmd by a user interface IU, the check STP? asks nxt_rq the user interface IU whether a new certified identity data item must be added to the profile ρu being generated, and in response receives a command nxt_nsw indicating whether the profile is complete or whether a new certified identity data item must be added.

[symbol]

In particular, if the check STP? determines that a new certified identity data item must be added, notably when not all the required data has been provided [N], then the check triggers a new iteration of the generation of a profile k=k+1 allowing the selection SLCT and integration of a k^{th} selected identity data item idcs^{U}(k) in the profile ρu being generated: p_{U}=ƒ(p_{U}, idcs^{U}(k)).

In particular, if the check STP? determines that the profile is complete (no new certified identity data item to be added or all the requested data is provided, for example) [Y], then the generation of the profile ρu is complete and the checking STP? optionally triggers the recording P_ST of the generated profile ρu.

In particular, the generation method comprises recording P_ST the generated profile p_{U}, notably in a profile database BPI.

The method for providing certified identity data for a profile according to an aspect of the present disclosure allows a user to consent to certain certified identity data items being delivered to a service provider (from a set of certified identity data items that they have previously obtained from identity providers). The certified identity data items sent to a service provider can be saved as a certified identity profile during the generation P_GN of a profile.

For example, the service provider SPV sends a request to the electronic wallet implementing the generation method P_GN in order for said electronic wallet to share and provide a certain amount of certified identity data.

Optionally, the user can select, by means of a user interface IU, the identity data to be sent to the service provider SPV from among those present in various certified identity data domains.

In particular, the certified identity data transmitted in response to the request from the service provider SPV can be saved P_ST as a certified identity profile.

Thus, the saved profile can be reused at a later date, notably in order to again respond to a request for certified identity data from the same service provider SPV or from another service provider collaborating with this first service provider.

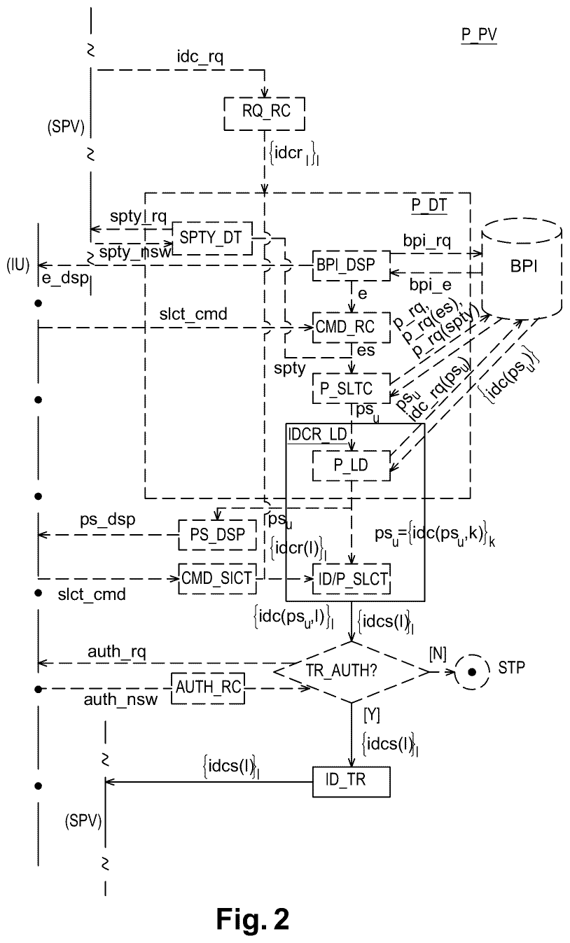

FIG. 2 illustrates a simplified diagram of the method for providing certified identity data according to an aspect of the present disclosure.

The method P_PV for providing certified identity data provides a service provider SPV with certified identity data {ids (I)}ₗ. The provision method P_PV comprises:
retrieving IDCR_LD the identity data {idcrᵢ}ᵢ required by a service provider from the identity data of a profile ps= {idc(ps, k)}ₖ of certified identities; and
transmitting the identity data retrieved from the profile {ids (I)} of certified identities to the requesting service provider SPV.

In particular, the provision method P_PV comprises:
receiving AUTH_RC a transmission agreement auth_nsw prior to transmitting the identity data ID_TR.

In particular, the retrieval IDCR_LD of identity data intended for a service provider SPV is carried out in an identity profile ps that has previously been used to provide P_PV the same service provider SPV with certified identity data.

In particular, the provision method P_PV comprises:
receiving RQ_RC a request idc_rq for certified identity data from the service provider SPV.

[symbol]

In particular, in the case whereby the provision P_PV of certified identities is carried out by selecting P_SLOT a profile psu as a function of a command slot_cmd received from a user interface IU, then the provision method P_PV notably comprises one or more of the following steps: [symbol]
providing BPI_DSP elements to be reproduced e_dsp relating to one or more profiles of certified identities associated with the user account U available bpi_e in the certified identity wallet, optionally on request bpi_rq for the provision BPI_DSP of elements to be reproduced relating to the profile of certified identities; [symbol]
receiving CMD_RC a selection command slct_cmd for a reproduced element e notifying the selection step SLCT of the selected reproduced element es as a function of which a profile selection step P_SLCT determines the corresponding profile psu.

In particular, in the case whereby the provision P_PV of certified identities is carried out by selecting P_SLOT a profile psu as a function of the type spty of service provider of the requesting provider, the provision method P_PV comprises:
determining SPTY_DT the type spty of service provider corresponding to the requesting service provider SPV.

Notably, determining SPTY_DT the type of service provider involves receiving information data spty_nsw originating from the service provider SPV, such as the type of service provider associated with the requesting service provider SPV or one or more items of information relating to the requesting service provider SPV allowing the type of service provider to be determined.

In particular, the provision method P_PV comprises:
selecting P_SLCT a profile psu of certified identities whose certified identity data idc(psu) will be provided to the service provider SPV by the provision of identity data P_PV.

[symbol]

In particular, when the step P_SLCT of selecting a profile selects several profiles likely to respond to the request (case not illustrated), the step P_SLCT of selecting a profile comprises one or more of the following steps: [symbol]
providing BPI_DSP elements to be reproduced e_dsp relating to the pre-selected profiles of certified identities likely to respond to the request bpi_e in the certified identity wallet;
receiving CMD_RC a selection command slct_cmd for a reproduced element e notifying the selection step SLCT of the selected reproduced element es as a function of which the step P_SLOT of selecting a profile determines the corresponding profile psu; [symbol]
loading, retrieving and/or receiving P_LD the identity data of the selected profile {idc(psu)}, notably in a profile database BPI, optionally in response to a request idc_rq (ps) for identity data.

Thus, pre-selecting the profiles as a function of the request allows the profiles that can be selected by the user, and therefore the errors or even failures in service provision, to be reduced.

In particular, the step P_SLOT of selecting a profile loads, retrieves and/or receives a selected profile psu, notably in a profile database BPI, optionally in response to a profile request p_rq, with the profile request notably comprising either the selected element es: p_rq(es) in the case of a selection command slot_cmd, or a type of service provider: p_rq (spty) in the case of determining SPTY_DT the type of requesting service provider SPV: p_rq (spty).

In particular, retrieving IDCR_LD identity data in a profile of certified identities comprises:

loading, retrieving, and/or receiving P_LD the identity data of a selected profile {idc(psu)}, notably in a profile database BPI, optionally in response to a request idc_rq (ps) for identity data.

In particular, the provision method P_PV comprises a step P_DT of determining a profile of certified identities comprising one or more of the following steps: [symbol]
providing BPI_DSP elements to be reproduced e_dsp relating to one or more profiles of certified identities associated with the user account U available bpi_e in the certified identity wallet;
receiving CMD_RC a selection command slot_cmd for a reproduced element e notifying the selection step SLCT of the selected reproduced element es as a function of which the profile selection step P_SLOT determines the corresponding profile psU;
determining SPTY_DT the type spty of service provider corresponding to the requesting service provider SPV;
selecting a profile psu of certified identities whose certified identity data idc(psu) will be provided to the service provider SPV by providing P_PV identity data;
loading, retrieving, and/or receiving P_LD the identity data of a selected profile {idc(psu)}, notably in a profile database BPI, optionally in response to a request idc_rq (ps) for identity data.

In particular, retrieving IDCR_LD identity data in a profile of certified identities comprises:
selecting ID/P_SCLT one or more certified identity data items {icds (psᵤ, l)}_{l,l≤L,l∈[1 . . . K]} from among all the certified identity data items of a profile of certified identities psu: {idcs(psu,k)}ₖ.

In particular, the selection ID/P_SCLT of certified identity data in the selected profile depends on the identity data requested {idcrₗ}ₗ by the requesting service provider SPV.

In particular, the provision method P_PV comprises one or more of the following steps: [symbol]
providing P_DSP elements to be reproduced ps_dsp relating to the selected profile;
receiving CMD_LSCR a selection command slot_cmd for selecting certified identity data from among all the certified identity data of a profile psu of certified identities: {idcs(psu,k)}ₖ, notably as a function of the elements reproduced ps_dsp following the provision P_DSP of elements to be reproduced relating to the selected profile ps_dsp.

In particular, the provision method P_PV comprises a check TR_AUTH? for checking a user authorization to provide certified identity data.

If the result of the check is negative [N], i.e., the user does not authorize [symbol]
the provision of certified identity data to the requesting service provider (non-agreement optionally previously recorded, for example, when the user subscribed to the requesting service provider or a non-agreement auth_nsw received AUTH_RC from the user when implementing the provision method P_PV, for example, in response to an authorization request auth_rq); and/or
the provision of one or more of the identity data items retrieved from the selected profile (in particular, when retrieving IDCR_LD certified identity data items from a profile automatically, for example, in a profile selected as a function of the type of requesting provider), (for example, non-agreement auth_nsw received AUTH_RC from the user when implementing the provision method P_PV, for example, in response to an authorization request auth_rq);
then the provision method P_PV is stopped STP without providing certified identity data originating from a profile. Optionally, stopping STP the provision of certified identity data originating from a profile P_PV triggers a provision of certified identity data without using the profiles, or even by creating a new profile as proposed by the generation method P_GN, notably as illustrated in FIG. 1, when it is the use of the certified identity data that is not authorized.

If the result of the check is positive [Y], i.e., the user agrees to providing the requesting service provider with the certified identity data (agreement optionally previously recorded, for example, when the user subscribed to the requesting service provider or an agreement auth_nsw received AUTH_RC from the user when implementing the provision method P_PV, for example, in response to an authorization request auth_rq), then the provision method P_PV transmits ID_TR the certified identity data originating from the selected profile {idcs(I)}ₗ.

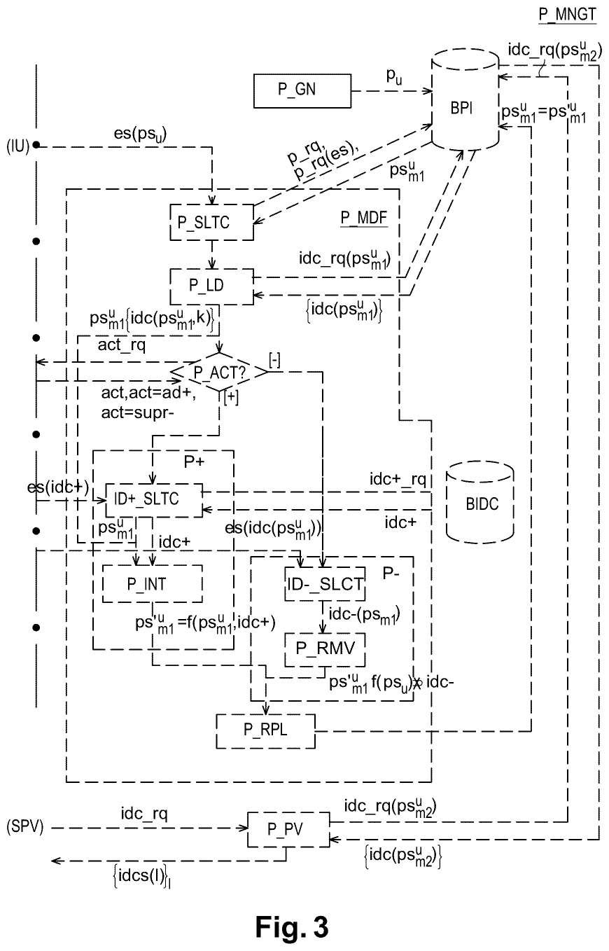

FIG. 3 illustrates a simplified diagram of the method for managing profiles of certified identities according to an aspect of the present disclosure.

The management method P_MNGT manages profiles ρu of certified identities associated with a user account U of an electronic identity wallet. The management method P_MNGT comprises:
generating P_GN a profile of certified identities according to an aspect of the present disclosure (notably as illustrated in FIG. 1).

In particular, the management method P_MNGT comprises:
modifying P_MDF a profile ps^{U}m1 of certified identities by modifying at least one identity data item of the profile idc(ps^{U}m1) of certified identities.

In particular, the modification P_MDF is a modification from among the following modifications [symbol]
adding P+a selected identity data item idc+, for the profile ps^{U}m1 of certified identities, from a set of identity data received from at least one certified identity provider associated with the user account IDP, IDP₁ . . . . IDP_{J} (not illustrated);
deleting P an identity data item from the profile idc(ps^{U}m1) of certified identities.

In particular, the management method P_MNGT comprises:
providing a service provider SPV according to an aspect of the present disclosure with identity data {idcs(I)}ₗ (notably as illustrated in FIG. 2).

In particular, the management method P_MNGT comprises:
selecting P_SLCT a profile psu of certified identities whose certified identity data idc(psu) will be managed by the profile management method P_MNGT.

[symbol]

In particular, the modification P_MDF comprises:
selecting P_SLCT a profile ps^{U}m1 of certified identities for which at least one certified identity data item idc(ps^{U}m1) will be modified by the modification P_MDF.

[symbol]

In particular, in the case whereby the management P_MNGT of profiles, notably the modification P_MDF, is carried out by selecting P_SLOT a profile psu, respectively ps^{U}m1, as a function of a command slct_cmd received from a user interface IU, then the management method P_MNGT, respectively the modification P_MDF, notably comprises one or more of the following steps: [symbol]
providing BPI_DSP (not illustrated) elements to be reproduced e_dsp relating to one or more profiles of certified identities associated with the user account U available bpi_e in the certified identity wallet, optionally on request bpi_rq for the provision BPI_DSP of elements to be reproduced relating to the profiles of certified identities; [symbol]
receiving CMD_RC (not illustrated) a selection command slot_cmd for a reproduced element e notifying the selection step SLCT of the selected reproduced element es (psu) as a function of which a profile selection P_SLOT determines the corresponding profile psu.

In particular, the profile selection step P_SLCT loads, retrieves and/or receives a selected profile ps^{U}m1, notably in a profile database BPI, optionally in response to a profile request p_rq, with the profile request notably comprising the selected element es: p_rq(es).

In particular, the management method P_MNGT, respectively the modification P_MDF, comprises:
loading, retrieving, and/or receiving P_LD the identity data of a selected profile {idc(ps^{U}m1)}, notably in a profile database BPI, optionally in response to a request for identity data idc_rq (ps^{U}m1).

In particular, the modification comprises P_MDF:
determining ACT? the type of modification act to be implemented, with the determining step ACT? triggering a modification P+, P− that is determined as a function of the type of modification that is determined act=ad+, act=supr-.

In particular, the step ACT? of determining the type of modification act receives the type of modification act, act=ad+, act=supr—from a user interface IU, optionally in response to a request for the type of modification type act_rq, notably from the determining step ACT?.

Notably, when the determining step ACT? determines a modification of the type involving adding a certified identity data item to the profile: [+], then the determining step triggers:
adding P+a selected identity data item idc+, for the profile ps^{U}m1 of certified identities, from a set of identity data received from at least one certified identity provider associated with the user account IDP, IDP₁ . . . . IDP_{J} (not illustrated). [symbol]
Notably, when the determining step ACT? determines a modification of the type involving deleting a certified identity data item in the profile: [-], then the determining step triggers:
deleting P. an identity data item from the profile idc. (ps^{U}m1) of certified identities.

In particular, adding P+a certified identity data item idc+ to a selected profile psu comprises:
selecting ID+_SLCT, for the selected profile psu of certified identities, an additional identity data item idcs+ from a set of identity data items {idcⱼ^{U}(n)}ⱼⁿ received from at least one certified identity provider IDP associated with the user account U; then
integrating P_INT the selected additional identity data item idc+=idcs^{U}(k) in the destination profile psu of certified identities.

In particular, when the profile modification P_GN is carried out by selecting ID+_SLOT and integrating P_INT, in the selected profile psu, an additional certified identity data item idc+ that is selected as a function of a selection es (icd+) received from a user interface IU:
selecting ID+_SLCT an additional identity data item, also called additional selection, involves receiving a selected reproduced element from a user interface that is associated with an additional selected certified identity data item idc+.

In particular, the additional selection ID+_SLOT requires the additional selected certified identity data idc+_rq, notably from the certified identity database BIDC, which then provides the additional selected certified identity data icd+=idcs^{U}(K+1), notably corresponding to one of the certified identity data items provided by one of the certified identity providers IDPⱼ: icd+=idcs^{U}(K+1)=idcⱼ^{U}(n)=id_{CIDPj}^{U}(n). The certified identity database BIDC comprises certified identity data items idc, notably all the certified identity data items provided by one or more certified identity providers IDP, IDP_{j,j=1 . . . J}: {idcⱼ^{U}(n)};n.

In particular, adding P+ notably comprises one or more of the following steps: [symbol]
providing BIDC_DSP (not illustrated) elements to be reproduced e_dsp relating to the certified identity data as a function of the certified identity data associated with the user account U available bidc_e in the certified identity wallet, optionally on request bidc_rq for the provision BIDC_DSP of elements to be reproduced relating to the certified identity data; [symbol]
receiving CMD_RC (not illustrated) a selection command slot_cmd for a reproduced element e notifying the step SLCT of selecting certified identity data of the selected reproduced element es as a function of which the selection step determines the corresponding additional certified identity data item idc+: es (idc+).

In particular, the integration step P_INT integrates an additional selected identity data item idc+=idcs^{U}(K+1) in the profile psₘ₁^{U} being modified: ps′ₘ₁^{U}=ƒ(psₘ₁^{U}, idc₊) and provides the modified profile ps′m1^{U} with a substitution P_RPL replacing the profile psₘ₁″ to which the additional identity data idc+ was added by the modified profile ps′ₘ₁^{U}, notably in the profile database BPI.

In particular, the removal or deletion P— of a certified identity data item idc— in a selected profile psₘ₁^{U} comprises:
selecting ID-_SLCT, from the selected profile psₘ₁^{U} of certified identities, an identity data item idc to be removed from among all the identity data items {idc(psₘ₁^{U})} notably received from the profile database BPI; then
removing P_RMV the selected identity data item to be removed idc. from the original profile psₘ₁^{U} of certified identities.

In particular, when the profile modification P_GN is carried out by selecting ID. SLOT and removing P_INT a certified identity data item to be removed from the selected profile psₘ₁^{U}, which certified identity data item is selected idc. as a function of a selection es (icd (psₘ₁^{U})) received from a user interface IU, then:
the selection ID._SLOT of an identity data item to be removed, also called removal selection, receives a selected reproduced element es from a user interface that is associated with a selected certified identity data item to be removed idc . . .

In particular, the removal P-notably comprises one or more of the following steps: [symbol]
providing BIDC_DSP (not illustrated) elements to be reproduced e_dsp relating to the certified identity data of the selected profile psₘ₁^{U} of certified identities as a function of the certified identity data associated with the selected profile psₘ₁^{U} available bidc_e in the certified identity wallet, optionally on request bidc_rq from the provision BIDC_DSP of elements to be reproduced relating to the certified identity data of the selected profile; [symbol]
receiving CMD_RC (not illustrated) a selection command slot_cmd for a reproduced element e notifying the step SLCT of selecting certified identity data of the selected reproduced element es as a function of which the selection determines the corresponding certified identity data to be removed idc: es (idc.).

In particular, the removal P_RMV removes a selected identity data item to be removed idc+=from the profile psₘ₁^{U} that is being modified: ps′iₘ₁^{U}=ƒ(psₘ₁^{U}) [symbol] idc_) and provides the modified profile ps′ₘ₁^{U} with a substitution P_RPL replacing the profile psₘ₁^{U} from which the identity data item to be removed idc. was removed with the modified profile ps′ₘ₁^{U}, notably in the profile database BPI.

In particular, the modification step P_MDF comprises:
substituting P_RPL the profile psₘ₁^{U} from which the modification was implemented with the modified profile ps′ₘ₁^{U} resulting from the modification, notably in the profile database BPI.

The provision P_PV of certified identity data provides a service provider SPV with certified identity data {ids (I)} 1. The provision method P_PV comprises:
retrieving (not illustrated), from the identity data, a profile psₘ₂^{U} of certified identities of the identity data idc_rq requested by a service provider SPV; and
transmitting (not illustrated) the retrieved identity data of the profile {ids (I)}ₗ of certified identities to the requesting service provider SPV.

Optionally, the provision P_PV of certified data comprises:
loading, retrieving and/or receiving (not illustrated) the identity data of a selected profile {idc(psₘ₂^{U})}, notably in a profile database BPI, optionally in response to a request idc_rq (psₘ₂^{U}) for identity data.

In a particular embodiment of at least one of the methods described above, one or more of these methods is implemented in the form of a program comprising program code instructions for executing the steps of the method for generating profiles of certified identities and/or of the method for providing certified identity data and/or of the method for managing profiles of certified identities when said program is executed by a processor.

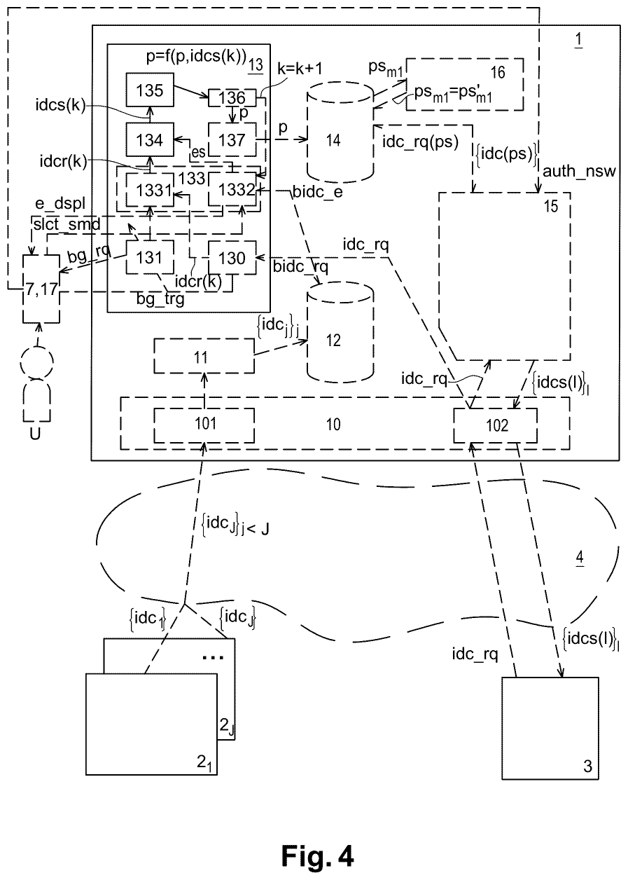

FIG. 4 illustrates a simplified diagram of a communication architecture comprising a certified identity wallet according to an aspect of the present disclosure.

The electronic certified identity wallet 1 is capable of providing certified identity data comprising a generator 13 for generating profiles of certified identities associated with a user account U of the electronic identity wallet 1, with the generator 13 for generating profiles of certified identities being capable of: [symbol]
selecting SLCT, for a profile ρu of certified identities, identity data idcs^{U}(k) from a set of identity data {idcⱼ^{U}(n)}ⱼⁿ, received from at least one certified identity provider IDPⱼ associated with the user account U; then
integrating P_INT the selected identity data idcs^{U}(k) in the recipient profile ρu of certified identities.

In particular, a communication architecture comprising the electronic certified identity wallet 1 comprises one or more of the following devices [symbol]
one or more identity providers 2₁ . . . 2_{J};
at least one service provider 3;
a user interface 7, 17;
at least one communication network 4 allowing the electronic certified identity wallet 1 to receive certified identity data from an identity provider 2₁ . . . 2_{J} and/or to transmit certified identity data to a service provider 3.

In particular, the electronic certified identity wallet 1 comprises:
a certified identity profile manager 16 capable of managing profiles ρu of certified identities associated with a user account U of the electronic identity wallet 1.

[symbol]

In particular, the electronic certified identity wallet 1, or even the certified identity profile manager 16 (case not illustrated), comprises:
the certified identity profile generator 13.

In particular, the electronic certified identity wallet 1, or even the certified identity profile manager 16 (case not illustrated), comprises:
a provider 15 for providing a service provider SPV with identity data {idcs(I)} . . .

In particular, the profile generator 13 comprises:
a certified identity data selector 134 capable of selecting, for a profile ρu of certified identities, identity data idcs^{U}(k) from a set of identity data {idcⱼ^{U}(n)}ⱼⁿ received from at least one certified identity provider 2ⱼ associated with the user account U;
an integrator 135 capable of integrating selected identity data idcs^{U}(k) provided by the selector 134 in the destination profile ρu of certified identities.

In particular, the certified identities data selector 134 is capable of selecting as a function of identity data idcr(k) required by at least one service provider SPV.

In particular, the certified identities data selector 134 is capable of selecting as a function of a selection command slot_cmd received from a user interface IU.

In particular, the profile generator 13 comprises:
a profile recorder 137 capable of recording, storing and memorizing the generated profile of certified identities, notably provided by the integrator 135.

In particular, when the profile ρu of certified identities is intended for a type spty of service provider, the certified identities data selector 134 is capable of selecting as a function of the type spty of service provider associated with the profile ρu of certified identities.

In particular, the integrator 135 for integrating the selected identity data idcs^{U}(k) in the profile ρu of certified identities is triggered int_trg as soon as the electronic identity wallet 1, in particular the provider 15, provides a service provider SPV with the selected identity data idcs^{U}(k), with the profile ρu of certified identities being associated with the service provider SPV.

In particular, the profile generator 13 comprises:
a starter 131 capable of starting the generation of a new profile associated with the user account U.

[symbol]

In particular, the starter 131 is triggered bg_trg for a new profile, notably: [symbol]
either by a request for a new profile b_trg from the user interface 7, 17;
or by a request receiver 130 following the receipt of a request idc_rq for certified identity data from a service provider SPV.

In the first case, the starter 131 asks b_rq a user interface 7, 17 whether the generation of a new profile is desired. In response to this request b_rq, the user interface 7, 17 triggers the starter 131 for a new profile.

In the second case, either the profile generator 13, or the profile manager 16 (case not illustrated), or the certified identity wallet 1 comprises:
a certified identity data request receiver 130 capable of receiving RQ_RC the certified identity data request idc_rq;
the starter 13 capable of being triggered bg_trg by the receiver 130 so that the starter 13 starts the generation of a new profile.

In particular, the profile generator 13 comprises:
a type of service provider analyzer (not illustrated) capable of determining the type spty of service provider with which the profile ρu of certified identities being generated will be associated.

In the first case, the type spty of service provider is indicated by the user interface 7, 17. Notably, the type spty of service provider analyzer receives a type spty_nsw of provider from the user interface 7, 17, for example, in response to a type spty_rq of service provider request sent by the user interface 7, 17.

In the second case, the type spty_rq of service provider is the type of the requesting service provider 3.

Notably, the type of service provider analyzer is capable of determining the certified identity data {idcr(k)}_{k≤K} generally required by the determined type spty of service provider: spty ({idcr(k)}_{k≤K}). “Generally required by” is understood to mean the certified identity data associated with the type of service provider recorded prior to the generation of a profile, and/or the history of the identity data associated with the service providers of the determined requesting type prior to the generation of the current profile, and/or the certified identity data associated with the type of service provider by learning, etc.

In particular, the profile generator 13 is capable of generating the profile by iteration, i.e., for a profile ρu comprising several identity data items, the generation method is capable of selecting and then integrating one identity data item after the other in the profile ρu.

For example, the starter 131 is capable of setting the iteration counter to 1: k=1, then triggering the selector 134 and the integrator 135 for a first selected identity data item idcs^{U}(k=1) in the profile pu: p_{U}=ƒ(p_{U}=Ø, idcs^{U}(k=1)). The profile generator 13 is notably capable of implementing an iteration k=k+1 as long as the generation of the profile has not been completed, allowing the selection and integration of a k^{th} selected identity data item idcs^{U}(k) in the profile ρu being generated: p_{U}=ƒ(p_{U}, idcs^{U}(k)).

In particular, in the case whereby the profile generator 13 is capable of generating a profile by selecting and integrating a selected certified identity data item idcs(k) as a function of a command slct_cmd received from a user interface IU in the profile p_{U}, then the profile generator 13 notably comprises one or more of the following devices: [symbol]
a provider 1332 for providing elements to be reproduced e_dsp relating to the certified identity data as a function of the certified identity data associated with the user account U available bidc_e in the certified identity wallet, optionally on request bidc_rq for the provision of elements to be reproduced relating to the certified identity data; [symbol]
a receiver 1332 for receiving selection commands capable of receiving a selection command slct_cmd for a reproduced element e notifying the selector 134 for selecting certified identity data of the selected reproduced element es as a function of which the selection determines the corresponding certified identity data idcs.

The provider of elements to be reproduced and the command receiver being either one and the same device 1332, or separate devices.

In particular, the certified identity data idc originating from one or more certified identity sources 2, 2₁ . . . 2_{J} have been previously recorded, for example, in a certified identity database 12.

In particular, the electronic identity data wallet 1 comprises the certified identity database 12.

In particular, in the case whereby the profile generator 13 is capable of generating as a function of the determined type spty of service provider, then the profile generator 13 notably comprises: [symbol]
a reader 1331 for reading certified identity data capable of reading the certified identity data required by the selected type spty of service provider. The reader notifies the selector 134 of certified identity data of a k^{th} required certified identity data item idcr(k).

In particular, in the case whereby the profile generator 13 is capable of generating following a request to provide certified identity data idc_rq from a service provider 3, then the profile generator 13 notably comprises one or more of the following devices [symbol]
a reader 1331 for reading the certified identity data requested by the service provider 3. The reader 1331 for reading certified identity data notifies the certified identity data selector 134 of the required certified identity data idcr(k);
a certified identity data transmitter (not illustrated) capable of providing the requesting service provider 3 with the certified identity data idcs(k) selected by the selector 134.

In particular, the selector 134 is capable of requesting the selected certified identity data idcs^{U}_rq, notably from the certified identity database 12, which then supplies the selected certified identity data idcs^{U}(k) notably corresponding to one of the certified identity data items provided by one of the certified identity suppliers 2ⱼ: idcs^{U}(k)=idc;^{U}(n)=id_{CIDPj}^{U}(n). The certified identity database 12 comprises certified identity data idc, notably all the certified identity data provided by one or more certified identity providers 2, 2_{j,j=1 . . . J}: {idcⱼ^{U}(n)}ⱼⁿ.

In particular, the profile generator 13 comprises a checker 136 for checking the generation stage of the profile able to be implemented after the integrator 135 for integrating a certified identity data item selected from the profile ρu being generated.

In particular, in the case of a profile generated as a function of a determined type spty of service provider, the checker 136 is notably capable of determining whether all the data {idcr(k)} associated with this determined type spty of service provider has been provided: spty ({idcr(k)}).

[symbol]

In particular, in the case of a profile generated when providing a service provider with identity data, the checker 136 is notably capable of determining whether all the data idcr(k) requested by the service provider 3 has been provided.

In particular, in the case of a profile generated by selection slct_cmd by a user interface IU, the checker 136 is capable of asking nxt_rq the user interface 7, 17 whether a new certified identity data item must be added to the profile ρu being generated, and in response is capable of receiving a command nxt_nsw indicating whether the profile is complete or whether a new certified identity data item must be added.

[symbol]

In particular, if the checker 136 determines that a new certified identity data item must be added, notably when not all the required data has been provided, then the checker 136 is capable of triggering a new iteration of the generation of a profile k=k+1 allowing the selection SLCT and integration of a k^{th} selected identity data item idcs^{U}(k) in the profile ρu being generated: p_{U}=ƒ(p_{U}, idcs^{U}(k)).

In particular, if the checker 136 determines that the profile is complete (no new certified identity data item to be added or all the requested data is provided, for example) [Y], then the generation of the profile ρu is complete and the checker 136 is capable of optionally triggering a recorder 137 capable of recording the generated profile ρu.

In particular, the profile generator 13 comprises the recorder 137 capable of recording the generated profile p_{U}, notably in a profile database BPI.

In particular, the electronic identity data wallet 1 comprises the certified identities profiles database 14.

In particular, the certified identities profile manager 16 comprises:
a modifier (not illustrated) for modifying a profile ps^{U}ₘ₁ of certified identities capable of modifying at least one identity data item of the profile idc(ps^{U}ₘ₁) of certified identities.

In particular, the modifier comprises at least one device from among the following devices [symbol]
an integrator capable of adding P+a selected identity data item idc+ to the profile ps^{U}ₘ₁ of certified identities from a set of identity data received from at least one certified identity provider associated with the user account 2, 2₁ . . . 2_{J};
a subtractor capable of deleting an identity data item from the profile idc. (ps^{U}ₘ₁) of certified identities.

In particular, the profile manager 16 comprises:
a profile selector (not illustrated) capable of selecting a profile psu of certified identities whose certified identity data idc(psu) will be managed by the profile manager 16.

[symbol]

In particular, the certified identities profile manager 16, respectively the profile modifier, comprises:
a loader/receiver for loading/receiving certified identity data of a profile (not illustrated) capable of loading, retrieving and/or receiving the identity data of a selected profile {idc(ps^{U}ₘ₁)}, notably in a profile database 14, optionally in response to a request idc_rq (ps^{U}ₘ₁) for identity data.

In particular, the profile manager 16, or even the profile modifier, comprises:
a profile recorder capable of substituting the profile psₘ₁^{U} from which the modification was implemented with the modified profile ps′ₘ₁^{U} resulting from the modification, notably in the profile database 12.

The certified identity data provider 15 is capable of providing a service provider 3 with certified identity data {ids (I)} I. The certified identity data provider 15 comprises:-a certified identity data loader (not illustrated) capable of retrieving, from the identity data, a profile psₘ₂^{U} of certified identities of the identity data idc_rq required by a service provider 3; and
a certified identity data transmitter (not illustrated) capable of providing the requesting service provider 3 with the retrieved identity data of the profile of certified identities {ids (I)}_{I}.

Optionally, the certified identity data provider 15 comprises:
a certified identity data loader (not illustrated) capable of loading, retrieving and/or receiving the identity data of a selected profile {idc(pₘ₂^{U})}, notably in a profile database 14, optionally in response to an identity data request idc_rq (psₘ₂^{U}).

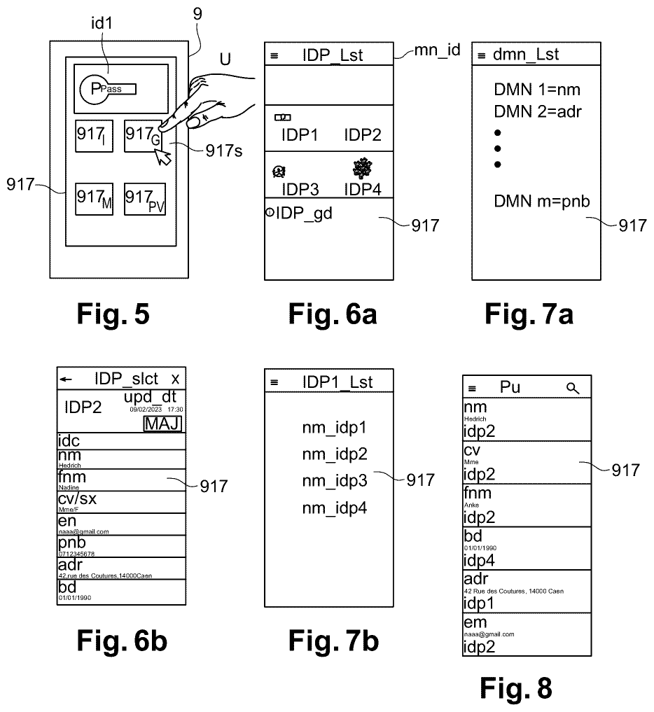

FIG. 5 illustrates a simplified diagram of the user interface allowing access to an electronic certified identity data wallet according to an aspect of the present disclosure.

A communication device 9, for example, a smartphone, a tablet or a computer comprises a screen forming a user interface 917. The user can interact with one or more elements reproduced by the screen 9, notably by means of an interaction peripheral device, such as a mouse, a stylus, etc., or directly when the screen 9 can be touched using a finger of the user U. In the case of interaction by means of an interaction peripheral device (mouse, joystick, touchpad, etc.), the interaction position is indicated on the screen by a cursor 917s.

The electronic certified identity data wallet notably provides reproducible interaction elements 917_{I}, 917_{G}, 917_{M}, 917_{PV} allowing the user to request processing of the electronic data wallet illustrated in FIGS. 1 to 3, or even allowing triggering of one of the devices of the electronic certified identity data wallet as illustrated in FIG. 4.

In particular, the interaction element 9171 is capable of controlling the loading of certified identity data (not illustrated) from a certified identity provider, notably in a certified identity database 12, prior to any generation or management of profiles according to an aspect of the present disclosure.

In particular, the interaction element 917| is capable of controlling the profile generator 13, notably as illustrated in FIG. 4, and/or the generation of profiles P_GN, notably as illustrated in FIG. 1.

In particular, the interaction element 917M is capable of controlling the profile manager 16, notably as illustrated in FIG. 4, and/or the profile management P_MNGT, notably as illustrated in FIG. 2.

In particular, the interaction element 917_{PV} is capable of controlling the provider 15 of certified identity data of a profile, notably as illustrated in FIG. 4, and/or the provision P_PV of certified identity data of a profile, notably as illustrated in FIG. 3.

FIG. 5 illustrates the case whereby the user U commands the generation of a new profile.

FIG. 6a illustrates a simplified diagram of the user interface during a first step of generating a profile according to an aspect of the present disclosure in a first embodiment, notably following a command as illustrated in FIG. 5.

In this first embodiment, in the first step of generating a profile, the user interface 917 proposes that the user selects the certified identity provider of a first certified identity data item of the profile being generated from among all the certified identity providers IDP1, IDP2, IDP3, IDP4 whose certified identity data items have been loaded into the certified identity database 12 of the electronic wallet 1.

In the example herein, the user selects the second certified identity provider IDP2 for this first certified identity data item of the profile being generated.

Thus, for another certified identity data item of the profile being generated, for example, the fourth data item, the user can select another certified identity provider IDPⱼ, j≠2, for example, the fourth identity provider IDP4.

FIG. 6b illustrates a simplified diagram of the user interface during a second step of generating a profile according to an aspect of the present disclosure in a first embodiment.

In this second step, with the user having selected a certified identity provider, in this case the second certified identity provider IDP2, the user interface 917 reproduces all the certified identity data IDP_slot provided by this second certified identity provider IDP2 in order to allow the user to select one of these certified identity data items.

In this case, the screen 917 displays the following certified identity data: the surname nm, the forename fnm, the title cv and the gender sx, an email em, a telephone number pn, a postal address adr, the date of birth bd, etc.

In the example herein, the user selects the certified identity data item corresponding to the name nm provided by the second certified identity provider IDP2 for this first certified identity data item of the profile being generated.

In particular, the screen 917 proposes a selection element MAJ allowing an update to be triggered in the certified identity database 12 of the certified identity data of the second certified identity provider IDP2 by checking whether the certified identity data available from the second certified identity provider IDP2 has been modified and, if so, replacing the corresponding certified identity data in the certified identity database 12 with the modified certified identity data retrieved from the second certified identity provider IDP2.

FIG. 7a illustrates a simplified diagram of the user interface during a first step of generating a profile according to an aspect of the present disclosure in a second embodiment, notably following a command as illustrated in FIG. 5.

In this second embodiment, in the first step of generating a profile, the user interface 917 proposes that the user selects an identity data domain from among several domains DMN1 . . . . DMNm, notably the domains corresponding to the different names nm, the different addresses adr, . . . , the different telephone numbers pnb, etc.

In the example herein, the user selects the first certified identity domain DMN1 for this first certified identity data item of the profile being generated.

Thus, for another certified identity data item in the profile being generated, for example, the fifth data item, the user can select another certified identity domain DMNm, m #1, for example, the second domain DMN2.

It should be noted that the domains can be subdivided into sub-domains, thus making it easier for the user to navigate through a significant amount of certified identity data.

FIG. 7b illustrates a simplified diagram of the user interface during a second step of generating a profile according to an aspect of the present disclosure in a second embodiment.

In this second step, with the user having selected a certified identity domain, in this case the first certified identity domain DMN1, the user interface 917 reproduces all the certified identity data DMN1_Ist associated with this first certified identity domain DMN1 in the certified identity database 12 in order to allow the user to select one of these certified identity data items.

In this case, the screen 917 displays the following certified identity data: a name provided by the first provider nm_idp1, a name provided by the second provider nm_idp2, a name provided by the third provider nm_idp3, a name provided by the fourth provider nm_idp4, etc.

In the example herein, the user selects the certified identity data item corresponding to the name nm_idp2 provided by the second certified identity provider for this first certified identity data item of the profile being generated.

FIG. 8 illustrates a simplified diagram of the user interface showing an example of a profile generated according to an aspect of the present disclosure.

The screen 917 reproduces all the certified identity data of the profile ρu. In this case, the profile ρu comprises:
a name nm provided by the second certified identity provider idp2;
a title cv provided by the second certified identity provider idp2;
a forename fnm provided by the second certified identity provider idp2;
a date of birth bd provided by the fourth certified identity provider idp4;
an address nm provided by the first certified identity provider idp1;
an email em provided by the second certified identity provider idp2; etc.

Thus, if the screen 917 is displayed during a profile management method P_MNGT, the user can select a certified identity data item to be removed from the profile.

Thus, if the screen 917 is displayed during a method P_PV for providing certified identity data from a profile, the user can select one or more of the certified identity data items from the certified identity data of the profile that is/are to be transmitted to a requesting service provider.

An aspect of the present disclosure therefore notably proposes a method and a system for managing identity profiles that maintains the privacy of users. The system is notably made up of a mobile application (a computer program capable of executing the steps of the method for managing profiles of certified identities) allowing a user to obtain their certified identity data from at least one certified identity provider with which they are registered. This application allows, asynchronously with their certified identity providers, their certified identity data to be provided to the providers of services they access.

Thus, an aspect of the present disclosure allows the user to control the sharing of their certified identity data. Furthermore, certified identity data is sent to a service provider without involving the one or more certified identity providers.

Therefore, an aspect of the present disclosure forms one or more profiles integrating certified identity data in order to grant access to certain services provided by one or more service providers.

An aspect of the present disclosure also relates to a medium. The information medium can be any entity or device capable of storing the program. For example, the medium can comprise a storage medium, such as a ROM, for example, a CD ROM or a microelectronic circuit ROM, or even a magnetic recording medium, for example, a floppy disk or a hard disk.

Moreover, the information medium can be a transmissible medium such as an electrical or optical signal that can be routed via an electrical or optical cable, by radio or by other means. In particular, the program according to an aspect of the present disclosure can be downloaded from a network, notably of the Internet type.

Alternatively, the information medium can be an integrated circuit, in which the program is incorporated, the circuit being adapted to execute or to be used to execute the method in question.

In another implementation, an aspect of the present disclosure is implemented by means of software and/or hardware components. For this purpose, the term module can equally correspond to a software component or a hardware component. A software component corresponds to one or more computer programs, one or more sub-programs of a program, or more generally to any element of a program or software capable of implementing a function or a set of functions as described above. A hardware component corresponds to any element of a hardware assembly capable of implementing a function or a set of functions.

An exemplary embodiment of the present disclosure overcomes the disadvantages/shortcomings of the prior art/to make improvements over the prior art.

Although the present disclosure has been described with reference to one or more examples, workers skilled in the art will recognize that changes may be made in form and detail without departing from the scope of the disclosure and/or the appended claims.

What is claimed is:

1. A method implemented by a device and comprising:
generating a profile of certified identities associated with a user account for an electronic identity wallet, the generating comprising:
selecting, for the profile of certified identities, identity data from a set of identity data received from at least one certified identity provider associated with the user account; then integrating the selected identity data into the profile of certified identities.

2. The method as claimed in claim 1, wherein at least one identity data item is selected as a function of identity data required by at least one service provider.

3. The method as claimed in claim 2, wherein at least one identity data item is selected as a function of a selection command received from a user interface.

4. The method as claimed in claim 1, the generation method comprising:
recording the generated profile of certified identities in a database on a non-transitory computer readable medium.

5. The method as claimed in claim 1, wherein, the profile of certified identities is intended for a type of service provider, and the selection is carried out as a function of the type of service provider associated with the profile of certified identities.

6. The method as claimed in claim 1, wherein integrating the selected identity data in the profile of certified identities is triggered as soon as the electronic identity wallet provides a service provider with the selected identity data, with the profile of certified identities being associated with the service provider.

7. A provision method implemented by a device and comprising:
providing a requesting service provider with certified identity data, the providing comprising:
retrieving identity data required by a requesting service provider from identity data of a profile of certified identities; and
transmitting the identity data retrieved from the profile of certified identities to the requesting service provider.

8. The provision method as claimed in claim 7, the provision method comprising:
receiving a transmission agreement prior to transmitting the identity data.

9. The provision method as claimed in claim 8, wherein the identity data intended for the requesting service provider is retrieved from the profile of certified identities, which has previously been used to provide the same requesting service provider with certified identity data.

10. The method as claimed in claim 1, wherein the method comprises managing the profile of certified identities associated with the user account for the electronic identity wallet.

11. The method as claimed in claim 10, the method comprising modifying the profile of certified identities by modifying at least one identity data item of the profile of certified identities.

12. The method as claimed in claim 11, wherein the modifying comprises performing a modification from among the following modifications:
adding a selected identity data item, for the profile of certified identities, from the set of identity data received from the at least one certified identity provider associated with the user account;
deleting an identity data item from the profile of certified identities.

13. The method as claimed in claim 10 the method comprising providing the requesting service provider with the identity data, the providing comprising:
retrieving identity data required by the requesting service provider from identity data of the profile of certified identities; and
transmitting the identity data retrieved from the profile of certified identities to the requesting service provider.

14. A non-transitory computer readable medium comprising program code instructions stored thereon for executing a method of generating a profile of certified identities associated with a user account for an electronic identity wallet, when said instructions are executed by a processor, the method comprising:
selecting, for the profile of certified identities, identity data from a set of identity data received from at least one certified identity provider associated with the user account; then
integrating the selected identity data into the profile of certified identities.

15. An electronic identity wallet capable of providing certified identity data, the electronic wallet comprising:
at least one processor; and
at least one non-transitory computer readable medium comprising instructions stored thereon which when executed by the at least one processor configure the electronic identity wallet to generate a profile of certified identities associated with a user account of the electronic identity wallet by:
selecting, for the profile of certified identities, identity data from a set of identity data received from at least one certified identity provider associated with the user account; then
integrating the selected identity data into the profile of certified identities.

16. A non-transitory computer readable medium comprising program code instructions stored thereon for executing a method of providing a requesting service provider with certified identity data, when said instructions are executed by a processor, the method comprising:
retrieving identity data required by a requesting service provider from identity data of a profile of certified identities; and
transmitting the identity data retrieved from the profile of certified identities to the requesting service provider.
